(19) United States
(12) Patent Application Publication
(10) Pub. No.: US 2026/0237697 A1
(43) Pub. Date: Aug. 13, 2026

(54) METHOD TO OPERATE A REDOX FLOW BATTERY AND REDOX FLOW BATTERY WITH IMMISCIBLE ELECTROLYTES

(71) Applicant: Unbound Potential AG, Thalwil (CH)

(72) Inventors: Niklas DENZ, Zürich (CH); David Phillipp TAYLOR, Thalwil (CH); Federico PARATORE, Zürich (CH); Gardar SKARPHEDINSSON, Zürich (CH)

(73) Assignee: Unbound Potential AG, Thalwil (CH)

(21) Appl. No.: 19/471,791

(22) PCT Filed: Apr. 2, 2024
(86) PCT No.: PCT/EP2024/058899

§ 371 Date: Oct. 2, 2025

(30) Foreign Application Priority Data
Apr. 3, 2023 (EP) 23020172.5

(51) Int. Cl. H01M 8/04186; H01M 8/18

(52) U.S. Cl. CPC H01M 8/04186; H01M 8/188

(57) ABSTRACT

A redox flow battery comprises a reaction chamber (1), a first and a second electrode arranged within the chamber (1), a first electrolyte (70) and a second electrolyte, wherein the first electrolyte and the second electrolyte are immiscible fluids forming within the reaction chamber a liquid-liquid interface (73) between them. A position of the liquid-liquid interface within the reaction chamber is stabilized.

### TECHNICAL FIELD

The present invention relates to a method to operate a redox flow battery and a redox flow battery with immiscible electrolytes.

### PRIOR ART

Redox flow batteries are deemed to be suitable for large-scale energy storage, especially of clean and sustainable energy such as from intermittent sources like wind and solar. Redox flow batteries are capable of scaling, and they have the potential to be reliable and cost-effective.

A redox flow battery is an electrochemical storage device that converts chemical energy into electrical energy through reversible oxidation and reduction of working fluids. The working fluids are called electrolytes, or anolyte and catholyte. They are usually liquids comprising redox active species, usually salts. A first and a second electrode (anode and cathode) are in contact with a first and a second of the electrolytes, respectively.

The name “redox” refers to chemical reduction and oxidation reactions through which energy is stored in the electrolytes, which flow through the reaction chamber (cell) of the battery during charge and discharge. The energy storing electrolytes are usually stored outside the reaction chamber in reservoirs (tanks). The reservoirs and the reaction chamber are connected with each other by at least one fluid circuit. A battery usually comprises at least one tank for each electrolyte, preferably a multiple of tanks, and a multiple of reaction chambers. “A multiple” means at least two, preferably three or more, even up to hundreds. The chambers can be arranged in parallel or in series. By changing Since the volume of the electrolyte tanks and the number of reaction chambers can be changed, the amount of energy and power can be scaled independently from each other.

The anolyte and the catholyte are usually separated by a separator, especially by an ion-selective membrane. The separator maintains electrical neutrality during operation and mitigates cross-over or cross-contamination of redox active species between catholyte and anolyte. EP 3 900 094 B1 discloses a redox flow battery comprising a separator between the two electrolytes.

The separator prevents the two electrolytes from mixing. However, such separators, especially the membranes, are quite expensive and the need to be replaced on a regular basis. This increases the costs for producing and maintaining such redox flow batteries.

WO 2021/209585 discloses a membrane-free redox flow battery using immiscible fluids as electrolytes and it discloses flow-through electrodes. This membrane-free battery has the advantage of reduced production and maintenance costs compared with the batteries using ion-selective separators and it is considered to ensure an increased performance.

### SUMMARY OF THE INVENTION

It is therefore an objective of the invention to provide an improved method to operate a redox flow battery and an improved redox flow battery comprising immiscible fluid electrolytes.

The inventive method to operate a redox flow battery uses a redox flow battery comprising a reaction chamber, a first and a second electrode arranged within the chamber, a first electrolyte and a second electrolyte, wherein the first electrolyte and the second electrolyte are immiscible fluids and wherein the two immiscible electrolytes form within the reaction chamber a liquid-liquid interface between them. The method comprises the step of stabilizing a position of the liquid-liquid interface within the reaction chamber.

The operation of the redox flow battery includes the steps of charging the battery and/or of discharging the battery and/or of maintaining the charged or partially charged battery for a later discharge or charge. Discharging does mean using at least some of the energy stored and is not to be understood as a step to always completely withdraw the energy stored within the battery.

The immiscible electrolytes are insoluble in each other. They form two phases when put into contact with each other. The electrolytes are preferably liquids. They are preferably different liquids. At least two different liquids are present.

The method allows to operate (run) a redox flow battery without any physical separator, wherein one liquid does not displace the other over time. Therefore, no separators, such as membranes, have to be present between the at least two electrolytes. Separators means ion-selective, or size-selective semi-permeable sheets of material, like Nafion® or PVDF (polyvinylidene difluoride).

Preferably, the electrolytes have different specific densities. Preferably, the electrolytes are arranged in horizontal layers within the reaction chamber, wherein the liquid-liquid interface extends horizontally.

The interface is preferably stabilized in a static state and in a dynamic state. This means that the interface is preferably stabilized when at least one of the two fluids is flowing and when none of the fluids is flowing.

In the invention claimed, the liquid-liquid interface is stabilized in either an active, a semi-passive or a fully passive way. In case of an active stabilization, the in- and outflow rates for each of the two liquids are preferably controlled, resulting in four control variables per reactor chamber. In a semi-passive stabilization, only the in- and out-flow of one of the electrolytes is preferably controlled, resulting in two control variables per chamber. In a fully passive stabilization, none of the in- and outflow rates have to be controlled. Reducing the number of control variables per chamber increases the scalability of the battery.

Preferably, the outflow rate of each electrolyte matches the inflow rate of each electrolyte. This can be achieved by actively controlling the out- and inflow rates.

In other embodiments, using the semi-passive stabilization, this can be achieved for example by designing the outflow of one electrolyte by a constant-pressure overflow boundary condition. For this liquid electrolyte, the outflowing, i.e. overflowing volume, always matches the inflowing volume, making an active control redundant for the flow rates of this liquid electrolyte. Only the in- and outflow rates of the other electrolyte have to be controlled then.

In other embodiments, using the fully passive approach, the outflow of both electrolytes is allowed via a constant-pressure overflow boundary condition. In that case, none of the flow rates has to be controlled actively. The interface between the two liquid electrolytes, apart from oscillations within a range of a few millimetres, is then independent from the inflow rates applied for either of the two electrolytes.

The step of stabilizing the position of the interface may allow a small amount of deviation, which is intrinsic to liquid flows. Usually, “a small amount” means less than the available space between the two electrodes, preferably as little as possible, e.g. under 20 mm.

Preferably, the first electrode is immersed in the first electrolyte and the second electrode is immersed in the second electrolyte, wherein the interface is stabilized such that first electrode is not immersed in the second electrolyte and the second electrode is not immersed in the first electrolyte. Therefore, in preferred variants of the method, the two electrodes are never immersed in the same electrolyte at the same time.

In preferred variants of the inventive method, the first electrolyte lies above the second electrolyte. The interface is stabilized such that the interface remains at an approximately constant level.

In some variants, the pressure boundary conditions in the reaction chamber are controlled. In some variants, the pressure boundary conditions surrounding the first and second electrolytes are controlled. In some variants, the pressure boundary conditions are controlled actively or passively.

In preferred variants, the pressure boundary conditions within the reaction chamber are kept constant and therefore independent from the pressure conditions at the electrolyte inflows in order to stabilize the position of the liquid-liquid interface. Preferably, the pressure boundary conditions surrounding the first and the second electrolyte are equal, and both kept constant.

The pressure boundary conditions above the open reaction chamber or generally in the closed or open reaction chamber can be controlled.

When the reaction chamber is open, the pressure boundary condition on top of the chamber is usually atmospheric pressure or a controlled pressure within a room in which the reaction chamber is arranged. This pressure is automatically sufficiently constant and does not have to be controlled. Therefore, the pressure boundary condition is controlled in a passive way.

In preferred variants, the reaction chamber is tightly closed. Preferably, tightly means hermetically or at least air or gas tightly, wherein the gas is a gas used within the chamber.

Preferably, the pressure boundary conditions within the reaction chamber and/or surrounding the electrolytes are controlled actively and/or passively. Preferably, the pressure condition of a gas layer is kept constant. Preferably, a slight constant overpressure in the range of 100 mbar is applied within the reaction chamber by means of the gas, preferably an inert gas, to maintain an oxygen-free atmosphere.

Preferably, the pressure boundary conditions are controlled by using at least one pressure valve or a multiple of pressure valves. The at least one valve is preferably a valve which opens and/or closes when a specific pressure is reached. The pressure valve is preferably an overpressure valve which opens automatically when an overpressure is reached.

Additionally or alternatively, the pressure boundary conditions are controlled by using a compressor. When a specific pressure is achieved over a reaction chamber, especially over an open reaction chamber or within the reaction chamber, the compressor and/or the valve can maintain the pressure boundary conditions constant. Pressure sensors are preferably used for tracking the performance only, but not for controlling the pressure boundary conditions.

Additionally or alternatively, a constant pressure can be set via a high-pressure reservoir in combination with a pressure reducing valve set to a constant pressure. The high-pressure reservoir may be a 200 bar N2 bottle (N2=nitrogen).

Preferably, in the semi-passive and fully passive approach, some or all of the pressure boundary conditions are kept constant by using an overflow of the first electrolyte and/or the second electrolyte at constant pressure. This use of an overflow is a passive control of the pressure boundary conditions. These variants have the advantage, that for the liquid electrolyte, or all liquid electrolytes, that overflow condition is applied to, the outflowing volume of electrolyte always matches the inflowing volume of that same electrolyte, independent of the inflowing flow rate. Herein, the top electrolyte can overflow over the top edge of the reaction chamber and/or the bottom electrolyte can overflow into a channel, gap or an intermediate storage basin or container. Hence, the semi-passive approach can be implemented in a straightforward way and can have the same geometry as a reaction chamber used with an active control approach.

For a fully passive approach, to enable an overflow of also the second, for example denser, electrolyte, the bottom of the reaction chamber is preferably linked to a neighbouring basin or reservoir filled with the second electrolyte. The overflow edge of the neighbouring basin or reservoir, and therefore the height of the bottom electrolyte in that reservoir, is preferably a few mm below the overflow edge of the reaction chamber and thus the filling height of the top electrolyte. The difference in filling height arises from the different specific density of the top and bottom electrolyte: the filling height of the top electrolyte is preferably a little higher, in order to match the hydrostatic pressure built in a liquid volume consisting of only bottom electrolyte liquid. The position of the interface between the two electrolytes in the reaction chamber is therefore preferably hard coded by the height of the two overflow boundaries for the top and bottom electrolyte, respectively.

Preferably, the method comprises the step of letting at least one of the first electrolyte and the second electrolyte flow through the reaction chamber, preferably by letting the first electrolyte and the second electrolyte flow through the reaction chamber. The step is preferably performed when charging and/or when discharging the battery. Preferably, at least one fluid flows during charging and discharging of the battery. Preferably, both fluids flow during charging and discharging. Depending on the battery, the electrolytes flow in the same direction or in counterflow to each other.

Preferably, the method therefore comprises the step of controlling an amount of an inflow and an outflow of the first electrolyte and/or the second electrolyte and/or using a passive approach for each of the two electrolytes, such that the inflow and the outflow of the first electrolyte match with each other and/or the inflow and outflow of the second electrolyte match with each other. Most preferred, there is no active control, but only the overflow approach is used.

Preferably, at least one inflow and at least one outflow is present for each reaction chamber. Preferably, both electrolytes have at exactly one inflow and one outflow. More than one inflow and one outflow for each electrolyte can be used as well. However, using just one inflow and one outflow for each electrolyte minimizes the control variable substantially, especially when using the semi-passive or active approach.

Preferably, the first electrolyte is a first fluid, and the second electrolyte is a second fluid, wherein the method comprises the step of using a third fluid located within the reaction chamber to stabilize the liquid-liquid interface between the first electrolyte and the second electrolyte.

In some embodiments, the third fluid is a liquid as well. Preferably, the third fluid is the gas, preferably the inert gas. In other variants, the gas is air, preferably environmental air. When using air, the reaction chamber is open on the top or it comprises at least air ducts within a top wall.

Preferably, this third fluid is not flowing, or only slightly flowing. In some variants, the pressure of the third fluid is automatically kept constant, for example due to pressure valve and/or a tank located outside of the reaction chamber, wherein the container stores additional third fluid and wherein the container is in fluid connection with the reaction chamber, thereby being able to equalize pressure fluctuations of the third fluid within the reaction chamber.

Preferably, the pressure boundary conditions are the pressure conditions of the third fluid.

The inventive redox flow battery comprises at least one reaction chamber, at least one fluid cycle, a first and a second electrode arranged within the reaction chamber, a first electrolyte and a second electrolyte. The first electrolyte and the second electrolyte are immiscible fluids. The two immiscible electrolytes form within the reaction chamber a liquid-liquid interface between them. According to a first aspect of the invention, the redox flow battery comprises means for stabilizing a position of the liquid-liquid interface within the reaction chamber.

This battery has the advantage that it can easily be controlled, since the variables to be controlled are minimized. In addition, the battery is easily scalable, since its design, not comprising a membrane, is much simpler and still, in most preferred embodiments, none of the electrolyte flow rates have to be controlled during charging and discharging of the battery. In a most preferred embodiment, none of the electrolytes have to be controlled at all.

The battery can comprise one tank for each electrolyte but a multiple of reaction chambers arranged in series or in parallel to each other. Several reaction chambers are arranged in series within a common housing. For each electrolyte for which the in- and outflow rates are controlled actively, neighbouring reaction chambers with a common housing share one common inflow port and one common outflow port for that electrolyte and all reaction chambers reside in the same liquid layer of that electrolyte.

As the electrodes within these reaction chambers are connected in series, the potential may differ between neighbouring reaction chambers, leading to significant current losses via the connecting electrolyte layer. Therefore, shields are preferably present between the reaction chambers. The reaction chambers are preferably open, and the shields are preferably arranged within the electrolyte layers.

The shields are physical structures, preferably labyrinth-like structures. They ensure continuity of the respective liquid layer of the electrolyte. These shields are especially used when the electrodes are plate-shaped and arranged in inserts. However, they can also be used with other shapes of electrodes and with electrodes which are arranged in the reaction chamber in another way.

These shields are also claimed as separate invention, i.e. without the stabilisation of the interface and even when using ion-separators.

In the active approach, the shields are preferably used for both electrolyte layers.

In a semi-passive approach, each reaction chamber has a separate, non-controlled inflow and an overflow of the first electrolyte, preferably the top electrolyte. The layer of the first electrolyte is separated by walls between the reaction chambers. Preferably, these walls do not extend through the second electrolyte layer, for which the in- and outflow is actively controlled commonly for all neighbouring reaction chambers. The shields are preferably placed in the second electrolyte layer in between the reaction chambers.

The shields can also be combined and/or directly implemented in the walls, thereby fully separating the first layers of electrolyte between neighbouring reaction chambers.

In a fully passive approach, each reaction chamber is preferably paired with a basin, also called neighbouring reservoir, to enable the overflow of also the second electrolyte. Each pair of reaction chamber and neighbouring reservoir is preferably fully separated from their neighbouring reaction chambers and/or form their neighbouring reservoirs. Preferably, each reaction chamber has separate inlets for each of the two electrolytes, as, for the passive approach, this does not increase the number of control variables. Due to the full separation of all reaction chambers, shields are not required in the fully passive approach.

Drainage structures, collecting the overflown electrolytes, respectively, are preferably shared by all pairs of reaction chamber and neighbouring reservoir. To minimize current losses, conducting liquid pathways between neighbouring pairs of reaction chamber and neighbouring reservoir should preferably be avoided. This can be achieved by designing the overflows in such a way that the overflowing electrolytes break up in droplets before being collected in the drains. A sequence of liquid droplets, due to the low conductivity of interlacing gas, presents a significantly higher electrical resistance than fully connected streams of electrolytes.

In preferred embodiments, the system comprises at least one fluid cycle with at least one pump for pumping at least one of the electrolytes through the reaction chamber. Preferably, both electrolytes are pumped in separate cycles through the reaction chamber.

In some embodiments, the redox flow battery comprises a control unit for setting and/or controlling a desired amount of inflow and outflow of at least one of the first electrolyte and the second electrolyte.

Preferably, the redox flow battery comprises a compressor and a pressure valve, preferably a pressure reducing valve. Preferably, the compressor and the valve are used to control the environment of the electrolytes and the electrolytes directly. The compressor is preferably not actively controlled and switches on below a certain pressure on the high-pressure side of the pressure reducing valve and the pressure reducing valve preferably is a fully passive device.

In preferred embodiments, the redox flow battery comprises a reservoir, a fluid cycle, and preferably a pump, for each of the first and the second electrolyte. The at least one pump is preferably controlled by the controller.

Preferably, the redox flow battery comprises a third fluid located within the reaction chamber and the neighbouring reservoir to provide constant pressure conditions and a pressure valve in fluid connection with the third fluid located in the reaction chamber. The third fluid is preferably a gas, preferably an inert gas or air. When an inert gas is used, the reaction chamber is preferably airtight. When air is used, the reaction chamber and, if present, the neighbouring reservoir are preferably not airtight so that an exchange can happen between the interior of the reaction chamber, and, if present, the neighbouring reservoir, respectively, and the environment.

Preferably the redox flow battery it is a membrane-free redox flow battery, wherein membrane-free preferably means free of a membrane or a similar component which would act as ion-separator between the two electrolytes.

In the following of this chapter “Summary of the invention”, a redox flow battery according to a second aspect of the invention is described. This redox flow battery can be the one described above. However, it can also not comprise all of the features mentioned above. Especially, it does not need to comprise the features mentioned above with regard to the first aspect of the invention.

This redox flow battery comprises a reaction chamber, a first and a second electrode arranged within the chamber, a first electrolyte and a second electrolyte. Preferably, the battery also comprises at least one storing reservoir and/or at least one overflow basin, also called neighbouring reservoir.

The first electrolyte and the second electrolyte are immiscible fluids. The two immiscible electrolytes form within the reaction chamber a liquid-liquid interface between them. According to the invention claimed in this second aspect, the first electrolyte lies above the second electrolyte and a third fluid is present to stabilize the liquid-liquid interface.

The third liquid can be a liquid or a gas. The gas can be air. Preferably, the third fluid is an inert gas.

In some embodiment, the basin or neighbouring reservoir is fluidically connected to the bottom of the reaction chamber and filled with the second electrolyte.

In a preferred embodiment using the fully passive approach, the filling height of the first electrolyte and the second electrolyte is defined by specifically designed overflow structures. In some embodiments, the combination of filling heights and specific density of the first and the second electrolyte determine the position of the interface between the first and the second electrolyte in the reaction chamber.

Using a third liquid enables maintaining a constant pressure boundary conditions at the overflow structures, so that the overflowing volume of an electrolyte always matches the inflowing volume of the same electrolyte. This reduces the variables which have to be controlled and ensures performance stability of the battery.

Preferably, the third liquid is arranged on top of the top electrolyte. When the third liquid is gas, it is arranged on the top of the electrolyte anyway.

Using a gas instead of an additional liquid has the advantage that gas can be handled more easily and can be provided from a compact high-pressure reservoir without the need for an additional fluid tank, as well as providing a more distinct interface between the different phases of liquid and gas.

In preferred embodiments of the first and the second aspect of the invention, the first electrode and the second electrode are combined to an insert which is inserted into the reaction chamber. This is claimed as a separate invention of a redox flow battery which may not have a stabilized liquid-liquid interface according to the batteries described above and which may even use ion-separators.

Using an insert comprising both electrodes, i.e. anode and cathode, has the advantage that an insert can be inserted and removed quite easily so that the production of the battery as well as the maintenance is simplified. In addition, the insert can be shaped such that the electrodes are stable, and the risk of damage is reduced. The insert forms a separate module which can be produced, transported, mounted into the reaction chamber, and removed from the reaction chamber as a whole and independently from other components of the battery. In addition, the insert enables an easy way of connecting the anode and cathode with the respective current collectors. Lastly it facilitates the closure and tightness of the reaction chamber, better ensuring no leaks.

Preferably, the insert comprises two plates, or preferably felts, held in a distance to each other by poles, wherein the plates, or felts, are the first and the second electrode.

The plates or felts can be flow-by electrodes. Preferably, they are flow-through electrodes.

In other embodiments of the first and the second aspect of the invention, the redox flow battery comprises an inlet and an outlet for the first and the second electrolyte, wherein the electrodes are arranged in or at a tube arranged in the inlets of the first and the second electrolytes. This is claimed as an additional separate invention of a redox flow battery which may not have a stabilized liquid-liquid interface according to the batteries described above and which may even use an ion-separator.

Arranging the electrodes at or in a tube arranged in the inlets of the first and second electrolytes has the advantage that the tube can be inserted and removed quite easily so that the production of the battery as well as the maintenance is simplified. In addition, the tube enables to mount the electrodes in a stable way and to fix them with regard to a housing of the reaction chamber. The risk of damage is reduced. The electrodes can be transported separately from the reaction chamber, and they can be removed from the reaction chamber for maintenance in an easy way. In addition, the tube enables an easy way for connecting the anode and cathode with the respective current collectors. Preferably, the tubes are made from a compatible conductive material, e.g. titanium, and function as current collectors themselves.

The invention claimed is not targeted to microfluidic redox flow batteries.

Further variants and embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a cross-section of a schematically illustrated inventive redox flow battery system according to a first embodiment;

FIG. 2 shows a cross-section of a schematically illustrated inventive redox flow battery system according to a second embodiment;

FIG. 3 shows a cross-section of a schematically illustrated inventive redox flow battery system according to a third embodiment;

FIG. 4 shows a top view of an insert of the battery according to FIG. 2;

FIG. 5 shows a cross-section of a schematically illustrated inventive redox flow battery system according to a fourth embodiment;

FIG. 6 shows a first cross-section of a schematically illustrated inventive redox flow battery according to a fifth embodiment;

FIG. 7 shows a second cross-section of the battery according to FIG. 6;

FIG. 8 shows a first longitudinal section taken through an upper part of the battery according to FIG. 6;

FIG. 9 shows a second longitudinal section taken through a lower part of the battery according to FIG. 6;

FIG. 10 shows an inner frame of the battery according to FIG. 6;

FIG. 11 shows a cross-section of a schematically illustrated inventive redox flow battery according to an sixth embodiment;

FIG. 12 shows a first longitudinal section taken through an upper part of the battery according to FIG. 11 and

FIG. 13 shows a second longitudinal section taken through a lower part of the battery according to FIG. 11.

### DESCRIPTION OF PREFERRED EMBODIMENTS

The expression “battery system” and “battery” are herein used as a synonym.

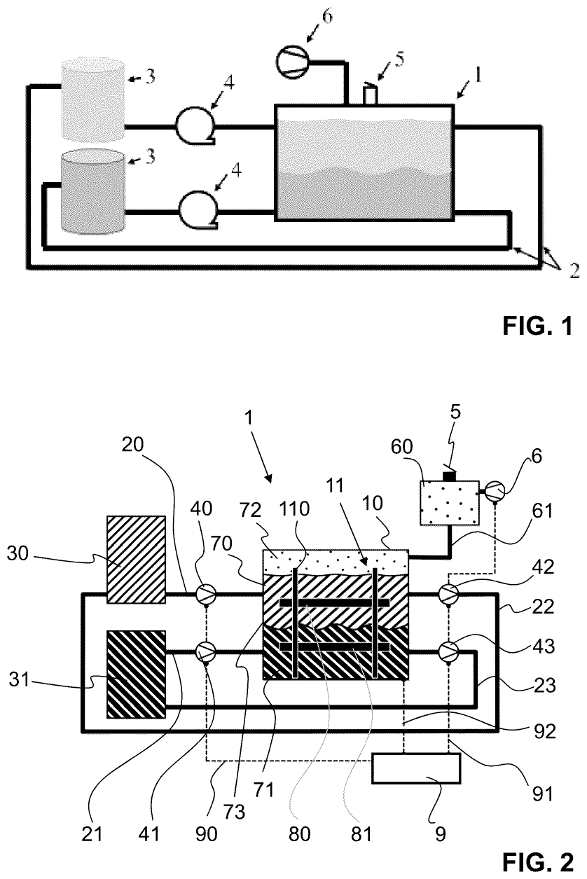

FIG. 1 illustrates a schematic view of an inventive redox flow battery system, where an electrochemical reactor 1 does not include a membrane but contains two immiscible liquids which are flown through the reactor 1. The fluid cycle consists of tubing 2, two reservoirs 3 for electrolyte storage and two pumps 4. An inventive boundary control system is depicted by a system comprising a compressor 6 for pressure control and a pressure valve 5.

FIG. 2 shows a battery using the same basic components. The above-mentioned electrochemical reactor is now called reaction chamber 1 or cell. The reaction chamber 1 comprises a housing 10, which is preferably air tightly closed in all the embodiments described in this chapter. However, in other embodiments using the same principles of the inventions described, the housing is open at the top or at least not airtight.

The battery further comprises a first fluid circuit with a first inlet tubing 20 and a first outlet tubing 22 connecting the reaction chamber 1 with a first reservoir 30. This first circuit and this first reservoir 30 is used for a first electrolyte 70.

The first electrolyte 70 is preferably a liquid, such as a hydrocarbon liquid, or an aqueous solution containing salts and, or polymers and, or water-soluble ionic liquids.

The battery further comprises a second fluid circuit with a second inlet tubing 21 and a second outlet tubing 23 connecting the reaction chamber 1 with a second reservoir 31. This second circuit and this second reservoir 31 is used for a second electrolyte 71.

The second electrolyte 71 is preferably a liquid, such as a hydrocarbon liquid, or an aqueous solution containing salts and, or polymers and, or water-soluble ionic liquids, such that it has a higher density and is immiscible with the liquid chosen as top electrolyte.

A first inlet pump 40 is used to pump the first electrolyte 70 from the first reservoir 30 into the reaction chamber 1. A first outlet pump 42 is used to pump the first electrolyte 70 from the reaction chamber 1 to the first reservoir 30.

A second inlet pump 41 is used to pump the second electrolyte 71 from the second reservoir 31 into the reaction chamber 1. A second outlet pump 43 is used to pump the second electrolyte 71 from the reaction chamber 1 to the second reservoir 31.

The flow direction of the two electrolytes 70, 71 through the reaction chamber 1 are in the same direction. In other embodiment, the liquids flow in opposite directions to each other, they are therefore in counterflow.

Instead of two pumps 40, 41, 42, 43 for each electrolyte 70, 71, a single pump can be used as well. This single pump can be arranged in fluid flow direction between the reservoir 30, 31 and the reaction chamber 1 as shown in FIG. 1, or it can be arranged in fluid flow direction after the reaction chamber 1.

The pumps 40, 41, 42, 43 are controlled by a controller 9. An according first control line 90 and a second control line 91 are shown in FIG. 2.

Within the reaction chamber 1, the first electrolyte 70 is arranged above the second electrolyte 71. They are immiscible liquids. They therefore form a liquid-liquid interface 73. The interface 73 extends approximately in horizontal direction. The arrangement of the liquids shown in the figures correspond to the real orientation in the physical device. The liquids are arranged one above the other, i.e. they are arranged in layers within the reaction chamber.

The flow direction is mainly from a left-hand side to a right-hand side or the other way round. In this embodiment, the main flow direction within the reaction chamber 1 is also this direction. However, in other embodiments shown later in this text, the flow within the reaction chamber 1 is more complicated.

Above the top electrolyte, here the first electrolyte 70, a third fluid 72 is present. The third fluid 72 is preferably a gas, most preferably an inert gas. The gas is inert, for example Helium, Neon, Argon, Krypton, Xenon, and most preferred Nitrogen.

The reaction chamber 1 is preferably connected via a gas line to a gas tank 60 comprising the same inert gas. A pressure valve 5, preferably a pressure reducing valve 5, is arranged either in the housing 10 of the reaction chamber, as shown in FIG. 1, or at the gas tank 60, which is preferably a high-pressure reservoir. It opens when a defined overpressure is reached in the gas tank 60. Preferably, the connection between gas tank 60 and reaction chamber 1 is always open, thereby equalizing the pressure of the inert gas 72 within the reaction chamber 1.

A compressor 6 is present to increase the pressure of the inert gas within the reaction chamber 1 directly, as shown in FIG. 1, or by increasing the pressure within the gas tank 60, thereby also enabling an increase of pressure in the reaction chamber 1, as shown in FIG. 2. The compressor 6 is also connected with the controller 9 and controlled by the controller 9, here through connection line 91.

The in- and outflow of the second electrolyte 71, which forms the bottom layer, is controlled. The control variables are the flow rates, which can be measured at the pumps, and the position of the interface, which is measured with a swimmer, which has a specific density between the density of the first and the second electrolyte and of which the position can be tracked externally optically or by sensors (e.g. hall sensors, in case of a magnetic swimmer) attached to the outside of the reservoir, or by the reflection of ultrasound from the liquid-liquid interface. This sensing system is not shown in the figure. The data of the sensor are communicated to the controller 9 via a sensing line 92.

The reaction chamber 1 also comprises electrodes and current collectors connecting the electrodes to the outside. The current collectors are well known in the state of the art, and they are not shown in these figures. They are usually sufficiently inert metallic structures connecting the electrodes to cables extending to the outside of the reaction chamber, wherein they should be sufficiently protected against the aggressive electrolytes 70, 71 within the reaction chamber 1.

The electrodes shown are reactive electrodes. Inert electrodes may be present or not. The inert electrodes, if present, are not shown in these figures.

In these figures, the electrodes are marked with the reference number 80 and 81, wherein the electrode 80 is preferably the anode during discharge and the electrode 81 is preferably the cathode during discharge.

Different types of shapes can be used for the electrodes 80, 81. The arrangement and fixation within the reaction chamber 1 can vary as well. In this preferred embodiment according to FIG. 1, the electrodes 80, 81 are plates, each immersed into one electrolyte 70. 71. Preferably, the electrodes 80, 81 are flow-through electrodes, i.e. the electrolyte can flow through the plate. In other embodiments, the electrodes 80, 81 are flow-by electrodes, i.e. the electrolyte flows around the electrodes.

In this embodiment, the two plates of the two electrodes 80, 81 are arranged parallel to each other and parallel to liquid-liquid interface 73. The are fixed in a defined distance from each other by poles 110, extending perpendicular to the plates. The poles 110 and the electrodes 80, 81 form together an insert. This insert, which is an independent module, can be inserted into the reaction chamber 1 as a single component, being independent from other components of the battery. Preferably, it is not fixed within the reaction chamber 1 with additional tools, but it just stands on the bottom of the housing 10 of the reaction chamber 1. In other embodiments the poles 110 are clamped between some walls of the reaction chamber or it is otherwise fixed. This insert can also be seen in FIG. 4.

The poles 110 are preferably made of a polymer. The electrodes 80, 81 are known as such in the state of the art and do not have to be explained in this text. Any kind of electrodes 80, 81 used in redox flow batteries can be used in this battery as well, as long as they match with the chosen pair of redox-active species.

When the battery is operated, i.e., charging, discharging, or storing energy for a later use, the following method is used:

When charging: both electrodes are flushed with the respective electrolyte in order to efficiently use the provided current for charging. The liquid-liquid interface between the first and the second electrolyte are controlled by actively matching the in- and outflow rates of the first and the second electrolyte, respectively, by means of flow rate sensors and/or an interface position sensing system and pumps linked in an active control loop.

When discharging: both electrodes are flushed with the respective electrolyte to provide the required discharge current. The liquid-liquid interface between the first and the second electrolyte are controlled by actively matching the in- and outflow rates of the first and the second electrolyte, respectively, by means of flow rate sensors and/or an interface position sensing system and pumps linked in an active control loop.

When storing energy for a later use: no flow is required. For minimizing the energy required for pumping the electrolytes, the pumps are preferably switched off in that case. While flow is halted, the interface position does not need to be controlled.

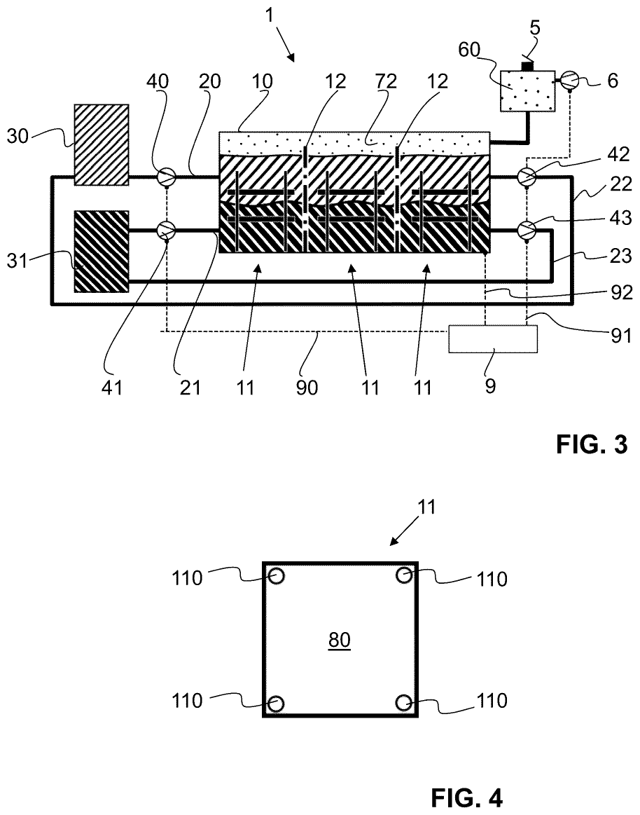

As can be seen in FIG. 3, the inventive battery comprises more than one reaction chamber 1. In this example, the reaction chambers 1 are connected in series. The reaction chambers 1, here three chambers, share the same housing. These chambers are open towards the neighbouring chambers. They can also be called conversion zones.

The housing has just one inlet and one outlet for each electrolyte 70, 71. The chambers 1 are only divided by shields 12, which let the electrolytes 70, 71 flow from one chamber into the next. In each chamber, an insert 11 with the anode 80 and cathode 81 as described above is present.

The shields 12 are physical structures which ensure continuity of the liquid layers surrounding the inserts. Preferably the shields are labyrinth-like structures. They can be clamped within the walls of the housing 10 or they can be fixed within the housing 1 in another way. Preferably, they are made of polymers to enable single-step additive manufacturing.

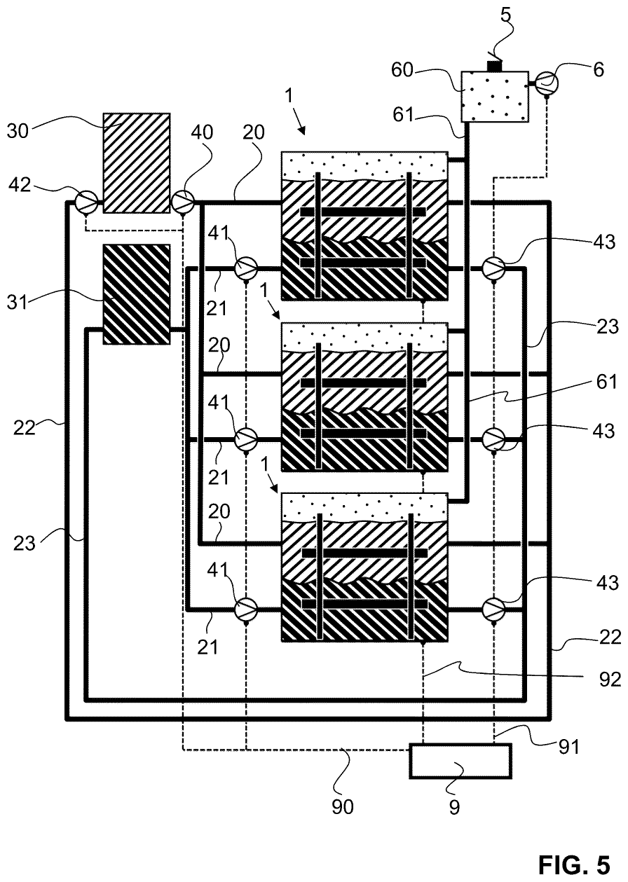

In FIG. 5, the reaction chambers 1 are connected in parallel. Each reaction chamber 1 has its own housing 10. The electrolytes 70, 71 flow to and from the same reservoirs 30, 31, but they do not flow through more than one reaction chamber 1 within the same cycle.

More pumps 40, 41, 42, 43 are shown in FIG. 5, wherein less pumps than shown can be used as well, in the embodiment according to FIG. 5 as well as in the embodiment according to FIG. 3. Using more pumps in the embodiment according to FIG. 5 enables the controller 9 to control the individual reaction chambers 1 individually.

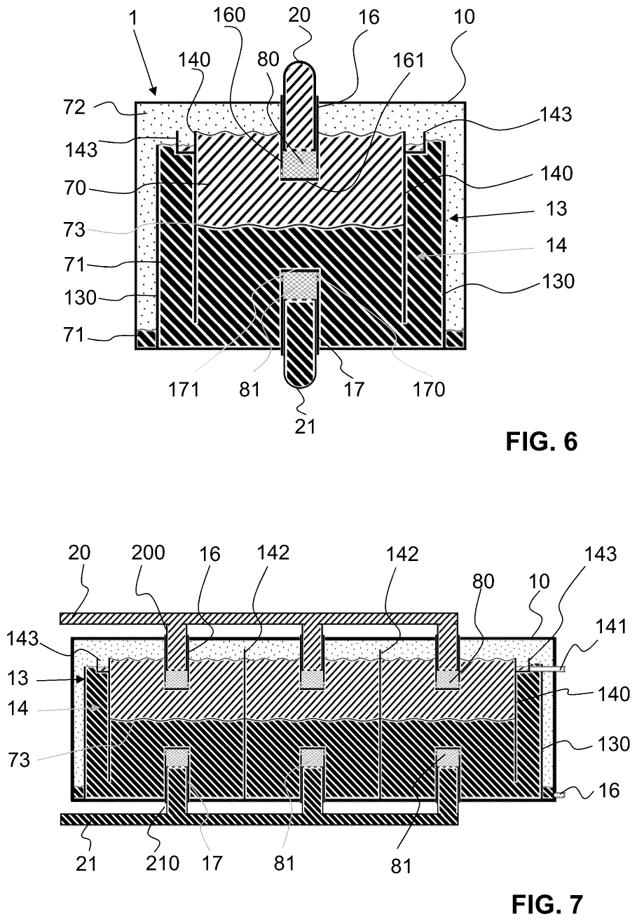

In FIGS. 6 to 10, a further embodiment of the inventive battery is shown. In this embodiment, a basin 13 is arranged within the housing 10. The basin 13 is open at the top and preferably closed at the bottom. The sidewalls of the basin are marked with reference number 130. These sidewalls 130 extend at a distance to the sidewalls of the housing 10, thereby forming a first circumferential gap. The bottom wall of the basin 13 can be a separate wall lying on the bottom wall of the housing 10 or it can be the bottom wall of the housing itself. The basin 13 is preferably made of a chemical resistant material, such as PE or PVC.

Within the neighbouring reservoir, herein also called basin 13, an inner frame 14 is arranged. The frame 14 is open on the top and at the bottom and closed in its circumference. The frame 14 has sidewalls 140 which extend above the sidewalls 130 of the basin 13. These sidewalls 140 extend at a distance to the sidewalls 130 of the basis 13, thereby forming a second circumferential gap. The inner frame 14 is preferably made of a chemical resistant material, such as PE or PVC.

In all examples shown, the housing 10 of the reaction chamber has a square or rectangular cross-section. However, it can have another shape as well, for example a round shape. The basin 13 and the inner frame 14 preferably have the same shape as the housing 10.

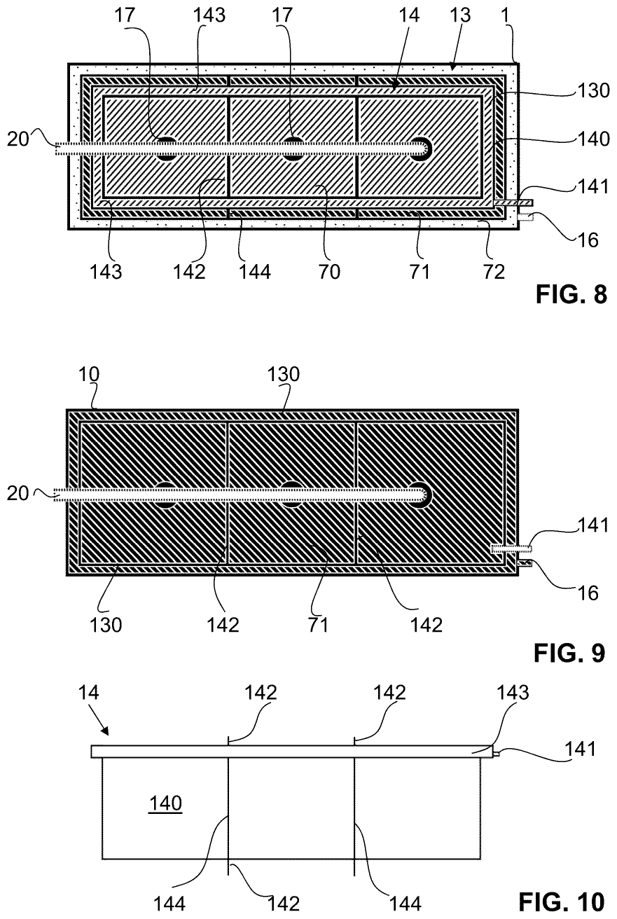

If the battery comprises only one reaction chamber, the inner frame 14 defines an inner space without additional walls. If two or multiple reaction chambers 1 are arranged in series, the inner frame 14 comprises in its interior partition walls 142, which also extend above the sidewalls 130 of the basin 13. Preferably, they extend also above the outer sidewalls 140 of the inner frame 14. The partition walls 142 can best be seen in FIGS. 7, 8 and 10. The partition walls 142 extend outside of the inner frame 14, forming vertical ribs 144 on the outside. The ribs 144 extend in horizontal direction to the sidewalls 130 of the basis 13, thereby interrupting the second circumferential gap. This can be seen in FIG. 8. In vertical direction, the ribs 144 extend only to the bottom end of the inner frame 14, so that the second circumferential gap is not interrupted at these places. This can be seen in FIG. 9. The inner part of the partition walls 142 however extend to the bottom of the basin 3. This can be seen in FIGS. 7 and 10.

The inner frame 14 comprises an overflow drain 143 which surrounds the outer side of the sidewalls 140. The overflow drain 143 is open on the top and extends only in the upper region of the sidewalls 140. The outer wall of the drain 143 has preferably the same height as the sidewalls 140. However, it can also be higher or lower.

The first inlet tubing 20 is preferably a pipe with a round cross-section. It extends above the housing 10 and along the length of the housing 10. Frist inlet pipes 200 lead from the first inlet tubing 20 to each reaction chamber 1, which are separated from each other by the partition walls 140. The housing 10 comprises at these places accordingly shaped first inlets 17. The first inlets 17 are preferably tubes extending into the reaction chambers, wherein the tubes comprise a fluid-tight cover 170 at their end face and through-openings 171 at the circumferential wall of the tube in the region of the cover 170. The first electrodes 80 are arranged within these first inlets 17, preferably behind the through-openings 171. The first electrodes 80 are preferably a carbon felts.

The second inlet tubing 21 is arranged at the lower side of the housing 10. It is also preferably a pipe with a round cross-section. It also extends above the housing 10 and along the length of the housing 10. Second inlet pipes 210 lead from the second inlet tubing 21 to each reaction chamber 1. The tubing 21 and the pipes 210 form a manifold.

The housing 10 comprises at these places accordingly shaped second inlets 18. The second inlets 18 are preferably tubes extending into the reaction chambers, wherein the tubes comprise a fluid-tight cover 180 at their end face and through-openings 181 at the circumferential wall of the tube in the region of the cover 180. The second electrode 81 are arranged within these second inlets 17, preferably behind the through-openings 181. The second electrodes 81 are preferably a carbon felts.

The first and the second inlet tubing 20, 21 are preferably identical as are the first and second inlets 17, 18.

The first and second inlet tubing 20, 21 and the first and second inlet pipes 200, 210 are preferably made of a polymer tube. The first inlets 17, 18 are preferably made of a chemical resistant material, such as titanium.

The inner frame 14 comprises a first outlet 141 which leads from the overflow drain 143 to the outside of the housing 10. It is connected to the tubing 2 as shown in FIGS. 1 to 3.

The housing 10 comprises a second outlet 16 which leads from the first circumferential gap to the outside of the housing 10. It is also connected to the tubing 2 as shown in FIGS. 1 to 3.

As can be seen in FIGS. 6 and 7, the second electrolyte 71 is pumped through the second inlet tubing 21 and through the second inlet pipes 210 to the second inlets 18. There it is pressed through the second electrodes 81 into the conversion zone of the reaction chambers.

Likewise, the first electrolyte 70 is pumped through the first inlet tubing 20 and through the first inlet pipe 200 to the first inlets 17. There it is pressed through the first electrodes 80 into the conversion zone of the reaction chambers.

The first and the second electrolytes 70, 71 form a liquid-liquid interface. Contrary to the embodiment according to FIG. 3, the electrolytes 70, 71 to not flow from a first reaction chamber into the next reaction chamber, but they flow in one reaction chamber or reaction zone only. However, they share common overflows and common outlets.

The first electrolyte 70 flows over the top of the sidewalls 140 of the inner frame 14 into the surrounding overflow drain 143 and then to the first outlet 141. This can best be seen in FIGS. 6, 7 and 8.

The second electrolyte 71 flows at the bottom of the inner frame 14 through the gap between the end of the sidewalls 140 of the inner frame 14 and the bottom of the basin 13 into the second circumferential gap. There it second electrolyte 71 rises and fills this gap until it reaches the upper end of the sidewall 130 of the basin 13. It then drops into the first circumferential gap between the sidewalls of the housing 10 and the sidewalls 130 of the basin 13. It can now leave the housing 10 through the second outlet 16. This can best be seen in FIGS. 6, 7 and 9.

The housing 10 is filled with a third fluid, preferably gas and most preferably an inert gas. The same description as above for FIGS. 1 to 5 applies. This housing is part of a redox flow battery system as shown and described above, especially as described with reference to FIGS. 1 to 5.

When the battery is operated, i.e., charging, discharging, or storing energy for a later use, the following method is used:

When charging: both electrodes need to be flushed with the respective electrolyte to efficiently use the provided current for charging. As the outflow of each of the electrolytes is preferably governed by a constant-pressure overflow boundary condition, the position of the interface between the electrolytes is defined by the position of the overflow drains in the reaction chamber and the neighbouring reservoir, respectively and the corresponding specific density of the two electrolytes. The inflow flow rates of neither of the two electrolytes have to be controlled actively.

When discharging: both electrodes need to be flushed with the respective electrolyte to provide the required discharge current. As the outflow of each of the electrolytes is preferably governed by a constant-pressure overflow boundary condition, the position of the interface between the electrolytes is defined by the position of the overflow drains in the reaction chamber and the neighbouring reservoir, respectively and the corresponding specific density of the two electrolytes. The inflow flow rates of neither of the two electrolytes have to be controlled actively.

When storing energy for a later use: no flow is required. For minimizing the energy required for pumping the electrolytes, the pumps can be switched off in that case. As the position of the interface between the top and the bottom electrolyte is defined solely by the position of the overflow drains and the difference in specific density between the two electrolytes, halting the flow does not significantly displace the interface.

The embodiment with only one overflow drain for the top first electrolyte differs from the control described above, since the in- and outflow rates of the second electrolyte need to be controlled actively. This embodiment is not shown in the figures.

In this not shown embodiment, the lower parts of several reaction chambers are connected, so that they share one common inlet for the second electrolyte and one common outlet for the second electrolyte, similar to the embodiment shown in FIG. 3. This reduces the number of control variables.

The bottom second electrolyte flows serially through the bottom sections of all connected reaction chambers. A direct fluidic connection of neighbouring reaction chambers leads to significant electrical loss currents, as the electrodes within the chambers are at different electrical potential. To minimize these loss currents, the electrical resistance between two reaction chambers can be maximized while still maintaining a continuous fluidic connection by the use of shields, which change the length and cross-section of the connection fluid pathway.

In contrast, when using two overflow drains as shown in FIGS. 6 to 16, one for each of the electrolytes, respectively, no flow rate has to be controlled actively. Thus, adding having separate in- and outflows for each electrolyte and each reaction chamber does not come with a penalty. In such a configuration, reaction chambers can be fully separated by walls and interconnecting shields are not required.

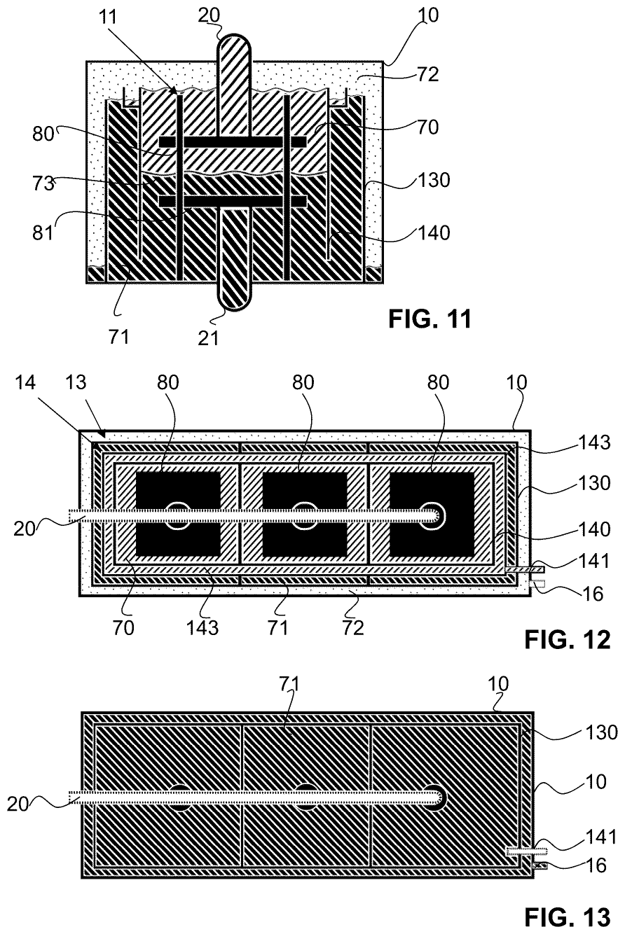

FIGS. 11 to 13 show an additional embodiment of the inventive redox flow battery. The battery comprises the features as described with reference to FIGS. 6 to 19. However, the electrodes 80, 81 are not placed within the inlet pipes 200, 210, but they are the inserts 11 as described with reference to FIGS. 2 to 5. Preferably, the inlet pipes 200, 210 are connected to the inserts 11 and preferably the electrodes 80, 81 are flow-through electrodes. The electrolytes 70, 71 are still pressed through the electrodes 80, 81. In other embodiments, the inserts 11 are arranged at a distance to the inlet pipes 200, 210, wherein the electrodes 80, 81 are flow-by or flow-through electrodes.

The sizes of a reaction chamber are typically about 30 cm (width) to 15 cm (height) to 70 cm (length). Other sizes can be used as well.

The invention enables a technically stable and economical battery.

LIST OF REFERENCE SIGNS

| | | | |
|---|---|---|---|
| 1 | reaction chamber (cell) | 4 | pump |
| 10 | housing | 40 | first inlet pump |
| 11 | insert | 41 | second inlet pump |
| 110 | pole | 42 | first outlet pump |
| 12 | shield | 43 | second outlet pump |
| 13 | basin (neighbouring reservoir) | 5 | pressure valve |
| 130 | sidewall | 6 | compressor |
| 14 | inner frame | 60 | gas tank |
| 140 | sidewall | 61 | gas line |
| 141 | first outlet | 70 | first electrolyte |
| 142 | partition wall | 71 | second electrolyte |
| 143 | overflow drain | 72 | gas |
| 144 | rib | 73 | liquid-liquid interface |
| 16 | second outlet | 80 | first electrode |
| 17 | first inlet | 81 | second electrode |
| 170 | cover | 9 | control unit |
| 171 | through-openings | 90 | first control line |
| 18 | second inlet | 91 | second control line |
| 180 | cover | 92 | third control line |
| 181 | through-openings | | |
| 2 | tubing | | |
| 20 | first inlet tubing | | |
| 200 | first inlet pipe | | |
| 21 | second inlet tubing | | |
| 210 | second inlet pipe | | |
| 22 | first outlet tubing | | |
| 23 | second outlet tubing | | |
| 3 | reservoir | | |
| 30 | first reservoir | | |
| 31 | second reservoir | | |

1. A method to operate a redox flow battery,
wherein the redox flow battery comprises a reaction chamber, a first and a second electrode arranged within the chamber, a first electrolyte and a second electrolyte, wherein the first electrolyte and the second electrolyte are immiscible fluids,
wherein the two immiscible electrolytes form within the reaction chamber a liquid-liquid interface between them,
wherein the method comprising the step of stabilizing a position of the liquid-liquid interface within the reaction chamber.

2. The method of claim 1 wherein the first electrode is immersed in the first electrolyte and the second electrode is immersed in the second electrolyte and wherein the interface is stabilized such that first electrode is not immersed in the second electrolyte and the second electrode is not immersed in the first electrolyte.

3. The method of claim 1, wherein the first electrolyte lies above the second electrolyte and wherein the interface is stabilized such that the interface remains at an approximately constant level.

4. The method of claim 1 wherein pressure boundary conditions within the reaction chamber are at least one of the following: kept constant and controlled in order to stabilize the position of the liquid-liquid interface.

5. The method of claim 4 wherein the pressure boundary conditions surrounding the first and the second electrolyte are at least one of the following: kept constant and controlled.

6. The method of claim 4 wherein the pressure boundary conditions are at least one of the following: kept constant at least one of actively and passively and controlled at least one of actively and passively.

7. The method of claim 4 wherein the pressure boundary conditions are controlled by using a compressor.

8. The method of claim 4 wherein the pressure boundary conditions are kept constant by using an overflow of at least one of the first electrolyte and the second electrolyte.

9. The method of claim 1 wherein the method comprises the step of letting at least one of the first electrolyte and the second electrolyte flow through the reaction chamber, preferably by letting the first electrolyte and the second electrolyte flow through the reaction chamber.

10. The method of claim 9 wherein the method comprises the step of controlling an amount of an inflow and an outflow of at least one of the first electrolyte and the second electrolyte such that at least one of the following match with each other: the inflow and the outflow of the first electrolyte, the inflow and outflow of the second electrolyte.

11. The method of claim 9 wherein the method comprises the step of providing an overflow for at least one of the flowing first and second electrolyte within the reaction chamber.

12. The method of claim 1 wherein the first electrolyte is a first fluid, and the second electrolyte is a second fluid and wherein the method comprises the step of using a third fluid located within the reaction chamber to stabilize the liquid-liquid interface between the first electrolyte and the second electrolyte.

13. The method of claim 12 wherein a gas, preferably an inert gas, is used as a third fluid.

14. A redox flow battery comprising at least one reaction chamber, at least one fluid cycle, a first and a second electrode arranged within the reaction chamber, a first electrolyte and a second electrolyte,
wherein the first electrolyte and the second electrolyte are immiscible fluids, and
wherein the two immiscible electrolytes form within the reaction chamber a liquid-liquid interface between them,
wherein the redox flow battery comprises means for stabilizing a position of the liquid-liquid interface within the reaction chamber.

15. The redox flow battery according to claim 14 wherein the at least one fluid cycle comprises a pump and wherein the redox flow battery comprises a control unit controlling an amount of inflow and an outflow of at least one of the first electrolyte and the second electrolyte in order to stabilize the position of the liquid-liquid interface.

16. The redox flow battery according to claim 14 comprising a compressor and preferably a pressure valve in order to stabilize the position of the liquid-liquid interface.

17. The redox flow battery according to claim 14 comprising a reservoir, a fluid cycle, and preferably a pump, for at least one or for each of the first and the second electrolyte.

18. The redox flow battery according to claim 14 comprising a third fluid located within the reaction chamber in order to stabilize the liquid-liquid interface.

19. The redox flow battery according to claim 18 comprising a pressure valve in fluid connection with the third fluid located in the reaction chamber.

20. A redox flow battery comprising a reaction chamber, a first and a second electrode arranged within the chamber, a first electrolyte and a second electrolyte,
wherein the first electrolyte and the second electrolyte are immiscible fluids, and
wherein the two immiscible electrolytes form within the reaction chamber a liquid-liquid interface between them,
wherein the first electrolyte lies above the second electrolyte and wherein a third fluid is present to stabilize the liquid-liquid interface.

21. The redox flow battery of claim 20 wherein the third fluid is an inert gas.

22. The redox flow battery of claim 20 wherein the first electrode and the second electrode are combined to an insert which is inserted into the reaction chamber.

23. The redox flow battery of claim 22 wherein the insert comprises two plates or felts held in a distance to each other by poles, wherein the plates or felts are the first and the second electrode.

24. The redox flow battery of claim 22 comprising an inlet and an outlet for the first and the second electrolyte, wherein the electrodes are arranged in or at a tube arranged in the inlets of the first and the second electrolytes.

25. The redox flow battery of claim 20 comprising walls within the reaction chamber enabling an overflow of at least one of the first and the second electrolyte within the reaction chamber in order to stabilize the liquid-liquid interface.

26. The redox flow battery of claim 20 wherein it is a membrane-free redox flow battery.
